(19) United States
(12) Patent Application Publication
(10) Pub. No.: US 2025/0265326 A1
(43) Pub. Date: Aug. 21, 2025

(54) MULTI-FACTOR AUTHENTICATION SYSTEM FOR VEHICLE THEFT PROTECTION

(71) Applicant: MAGNA INTERNATIONAL INC., Aurora (CA)

(72) Inventors: Julian KNUTZEN, Toronto (CA); Victoria Shkreli PACILLI, Windsor (CA)

(21) Appl. No.: 19/052,813

(22) Filed: Feb. 13, 2025

Related U.S. Application Data
(60) Provisional application No. 63/553,793, filed on Feb. 15, 2024.

(51) Int. Cl. G06F 21/40; G06F 21/32; G06F 21/60; G06V 40/16; G07C 9/00; G10L 17/00

(52) U.S. Cl. CPC G06F 21/40; G06F 21/32; G06F 21/604; G06V 40/172; G07C 9/00309; G10L 17/00; G06F 2221/2141; G07C 2009/00984

(57) ABSTRACT

A multi-factor authentication system for a vehicle includes: a biometric sensor located in the vehicle and configured to detect a unique characteristic of an authorized person; an access control device located in the vehicle and configured to selectively control access to a vehicle function; a security controller located in the vehicle and configured to operate the access control device based on a detection of the unique characteristic of the authorized person; and a user device capable of being carried by a user and configured to communicate with the security controller for controlling access to the vehicle and for changing a setting regarding accesses permissions for controlling operation of the access control device based on a detection of the unique characteristic of the authorized person and/or based on a signal from a key fob.

### CROSS REFERENCE TO RELATED APPLICATIONS

This U.S. utility patent application claims the benefit of and priority to U.S. Provisional Patent Application Ser. No. 63/553,793, filed Feb. 15, 2024, the contents of which is incorporated herein by reference in its entirety.

### FIELD

The present disclosure relates generally to a method and system for authenticating an authorized user of a vehicle, such as a passenger car or truck.

### BACKGROUND

Technical solutions for authenticating an authorized user of a vehicle and limiting access to vehicles and/or limiting functionality of vehicles based on such authorization have several limitations. Key fobs can be lost, stolen or damaged. Passcodes, such as numeric passwords can be forgotten and/or used by persons without authority to do so or after such authority lapses. Biometric authorization systems, such as fingerprints, may be used but can create additional complexity and difficulty, such as for managing details permissions associated with authorized persons.

### SUMMARY

The present disclosure also provides a multi-factor authentication system for a motor vehicle. The multi-factor authentication system includes: a biometric sensor located in the vehicle and configured to detect a unique characteristic of an authorized person; an access control device located in the vehicle and configured to selectively control access to a vehicle function; a security controller located in the vehicle and configured to operate the access control device based on a detection of the unique characteristic of the authorized person; and a user device capable of being carried by a user and configured to communicate with the security controller for controlling access to the vehicle and for changing a setting regarding accesses permissions for controlling operation of the access control device based on a detection of the unique characteristic of the authorized person.

The present disclosure also provides a method for authenticating a user of a vehicle. The method includes: detecting, using a biometric sensor located in the vehicle, a unique characteristic of an authorized person; selectively controlling, using an access control device located in the vehicle, access to a vehicle function; operating, by a security controller located in the vehicle, the access control device based on a detection of the unique characteristic of the authorized person; and communicating with the security controller, by a user device capable of being carried by a user, for controlling access to the vehicle and for changing a setting regarding accesses permissions based on the detection of the unique characteristic of the authorized person.

### BRIEF DESCRIPTION OF THE DRAWINGS

Further details, features and advantages of designs of the invention result from the following description of embodiment examples in reference to the associated drawings.

FIG. 1 shows a schematic block diagram of a system, in accordance with an aspect of the present disclosure; and

FIG. 2 shows a flow chart of steps in a method for authenticating a user of a motor vehicle, in accordance with some embodiments of the present disclosure.

### DETAILED DESCRIPTION

Referring to the drawings, the present invention will be described in detail in view of following embodiments.

To overcome the technical limitations of the existing approaches, the present disclosure provides a system and method for multi-factor authentication. The method and system of the present disclosure may be used for vehicle theft protection. Additionally or alternatively, the method and system of the present disclosure may be used for controlling access to contents of a motor vehicle and/or limiting functionality of the vehicle based on permissions associated with a given person.

The present disclosure provides a multi-factor authentication system (in addition to key fob) for vehicle theft protection allowing a flexible combination of various systems and approaches. The multi-factor authentication system may incorporate biometric sensing, a user device, and/or a combination thereof. The biometric sensing may include facial recognition leveraging new or existing cameras in vehicle, such as: driver monitoring system (DMS) cameras, surround-view cameras, and/or other cameras. The biometric sensing may include fingerprint sensors and/or speech recognition using in-cabin or external microphones for user authentication. The user device may include, for example, a permitted, coupled phone (e.g., through Bluetooth/NFC/UWB) to unlock and/or start the vehicle. The system may send an authorization request to phone/smartwatch (specific app) of permitted user(s) to allow vehicle start. This could be transmitted through Bluetooth/NFC, Wi-Fi or cellular service.

The multi-factor authentication system may provide a biometrics-based main additional authentication system. Persons that are not previously permitted/set-up can be unlocked through phone app by owner/permitted driver, either for a single time, a pre-set number of times or a pre-set time period (e.g., for 24 h). In some embodiments, a biometric characteristics for a person to be added as an authorized user can be acquired through the app. on an authorized personal device/phone. For example, a camera, microphone and/or fingerprint sensor of the authorized personal device (e.g., smartphone) may be used to collect biometric data. The authorized personal device may then send the biometric data to the safety controller in the vehicle through Bluetooth, Wi-Fi, NFC or cellular networks. Such data regarding the person to be added as an authorized user may be set to authorize that person for a single time, a pre-set number of times, a pre-set period of time or indefinitely. In some embodiments, the system may ask (e.g., randomly) for additional confirmation on phone app./smartwatch. This additional confirmation request may be selectively enabled and/or adjusted based on user preferences or settings. The occurrence or frequency of such an additional confirmation request may also be influenced by a geographic location of the vehicle. Furthermore, the system may “learn” regular usage patterns of the vehicle and send out more frequent additional confirmation requests if the vehicle is operated outside of normal patterns (in principal similar to credit card fraud detection systems). All of these occurrences, or thresholds for occurrences may be configured by the user. In some embodiments, the smartphone app. can also be used to remotely disable vehicle (e.g., if vehicle is in cellular/mobile data service range).

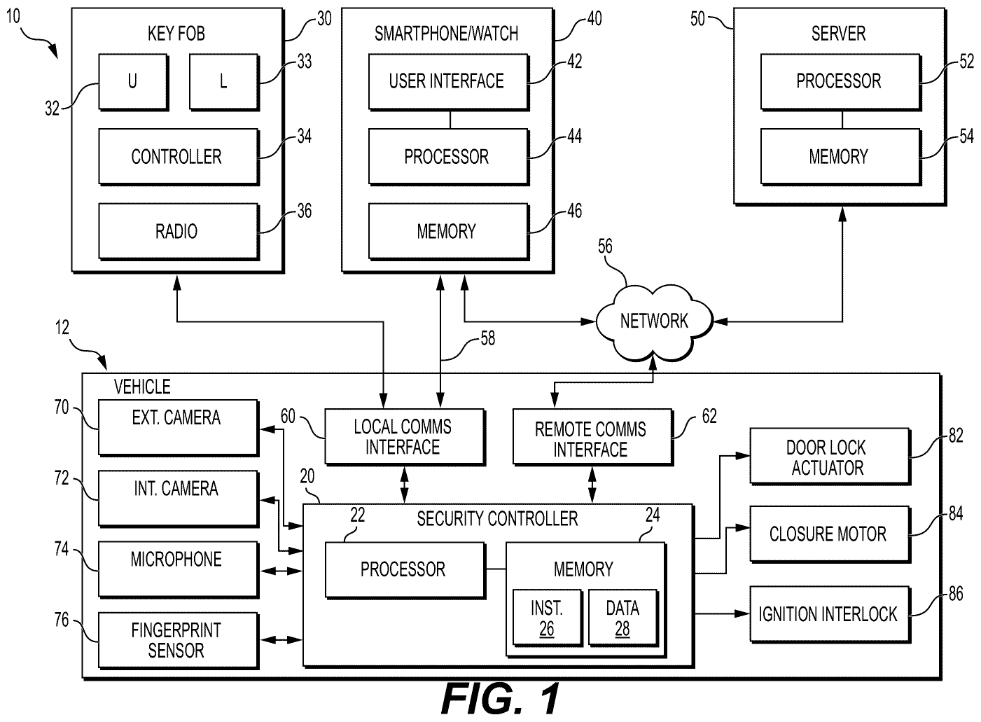

FIG. 1 shows a block diagram of system 10 in accordance with an aspect of the present disclosure. The system 10 includes a vehicle 12 with a security controller 20 located therein. The security controller 20, which may also be called a security electronic control unit (ECU), includes a first processor 22 coupled to a first storage memory 24. The first storage memory 24 stores instructions, such as program code for execution by the first processor 22, in a first instruction storage 26. The first storage memory 24 also includes a first data storage 28 for holding data to be used by the first processor 22. The first data storage 28 may store authentication data regarding one or more devices and/or users for use by the first processor 22 for controlling access to and/or functions of the vehicle 12.

The system 10 also includes a key fob 30 to be carried on the person of a user of the vehicle 12 (e.g., in a pocket, purse, or otherwise worn on the user's body) and for controlling access to the vehicle 12. The key fob 30 includes an unlock button 32 and a lock button 33 for remotely locking and unlocking doors and/or other closures of the vehicle 12. The key fob 30 also includes a controller 34 and a radio 36 for wirelessly communicating with the vehicle. In some embodiments, the key fob 30 may provide keyless access to the vehicle 12, which may enable one or more vehicle functions, such as locking, unlocking, starting, etc. based on proximity of the key fob 30 to the vehicle 12 and without the use of the buttons 32, 33. In some embodiments, the key fob 30 may use radio-frequency identification (RFID) technology. The key fob 30 may be provided in various different form factors, such as a keychain fob, credit card, etc.

The system 10 also includes a user device 40 capable of being carried by a user. The user device 40 may be carried on the person of the user (e.g., in a pocket, purse, or otherwise worn on the user's body). The user device 40 may include, for example, a smartphone or smart watch. The user device 40 includes a user interface 42, such as a touchscreen, speaker, microphone, etc. The user device 40 also includes a second processor 44 operably coupled to a second storage memory 46. The system 10 also includes a server 50, which may include one or more computers, and which are located remotely from the vehicle 12. The server 50 includes a third processor 52 operably coupled to a third storage memory 54. The server 50 is configured to communicate with the security controller 20 in the vehicle 12 via one or more data networks 56. The data networks 56 may include one or more wired and/or wireless networks, such as local area networks (LANs), wide area networks (WANs), the internet, cellular data networks, satellite communications networks, etc. In some embodiments, the user device 40 may also be configured to communicate with the security controller 20 in the vehicle 12 via the one or more data networks 56. Additionally or alternatively, the user device 40 may be configured to communicate with the security controller 20 in the vehicle 12 directly via a direct connection 58. The direct connection may include, for example, a short-range wireless communications interface, such Bluetooth, Near-Field communications (NFC), Ultra-wideband (UWB) short-range, Wi-Fi, etc.

The user device 40 may include one or more applications, also called apps, which may be stored on the second storage memory 46, and which may enable a user to interact with the security controller 20 in the vehicle 12 via the user interface 42. One such app. may provide for vehicle security control and settings, enabling an authorized user to access the vehicle 12 and/or to control system settings, such as authorization of particular individuals for specific vehicle functions. For example, an authorized person may use the app. to set permissions for another person to unlock and access the vehicle 12 and/or to operate the vehicle 12 for a set number of access instances, such as single time, a pre-set number of times, and/or a pre-set time period (e.g., for 24-hours) or for an indefinite amount of time.

In some embodiments, the user device 40 may be configured to measure a biometric characteristic of the person. For example, the user device 40 may measure a fingerprint, a face, or a voice characteristic of a person to be added as an authorized user. The user device 40 may send, to the security controller 20, data regarding the biometric characteristic of the person. The security controller 20 may be further configured to use the data regarding the biometric characteristic of the person for determining the unique characteristic of the authorized person. For example, the security controller 20 may receive hash data representing a fingerprint of an authorized person from the user device 40. The security controller 20 may subsequently compare that hash data to a new hash value from a fingerprint sensor 76 on the vehicle 12 in order to determine if a person attempting to access the vehicle 12 matches the biometric characteristics of the authorized person. Similar biometric registration and validation may be performed for camera-based or sound-based sensors or for other biometric identification.

The system 10 also includes one or more local communications interfaces 60 located in the vehicle 12 and configured to provide the direct communications between the security controller 20 and one or more external devices, such as the key fob 30 and/or the user device 40. The local communications interfaces 60 may include radios, modems, antennas, etc. The system 10 also includes one or more remote communications interfaces 62 located in the vehicle 12 and configured to provide communications between the security controller 20 and one or more external devices, such as the user device 40 and/or the server 50, via the one or more data networks 56. The remote communications interfaces 62 may include radios, modems, antennas, etc. The remote communications interfaces 62 may include, for example, an LTE cellular data modem and/or a data modem configured to communicate via a satellite-based communications network.

The system 10 also includes one or more biometric sensors 70, 72, 74, 76 for detecting one or more unique characteristics of a particular person. The biometric sensors 70, 72, 74, 76 may include cameras or other sensors that may be used for other purposes in the vehicle 12. The system 10 may be configured to perform facial recognition using new or existing cameras of the vehicle 12. The biometric sensors 70, 72, 74, 76 may include one or more external cameras 70 configured to view outside of the vehicle, and which may be used in other systems to provide an operator with a view behind or around the vehicle 12. The one or more external cameras 70 may include, for example, a camera in an outside rear view mirror, a backup rear-view camera, etc. The biometric sensors 70, 72, 74, 76 may include one or more internal cameras 72 configured to view inside of the vehicle. The one or more internal cameras 72 may include, for example, cameras located in an inside mirror, steering column, headliner, A-pillar, etc. The one or more internal cameras 72 may also function as components of a driver monitoring system that is configured to view a driver and/or other occupant of the vehicle 12. The security controller 20 may be configured to perform the facial recognition using the one or more external cameras 70 and/or the one or more internal cameras 72 in order to authenticate a person who is an authorized user of the vehicle 12.

The biometric sensors 70, 72, 74, 76 may include one or more microphones 74, which may be located externally and/or internally, within a passenger compartment of the vehicle 12. The security controller 20 may be configured to perform speech recognition using the one or more microphones 74 in order to authenticate a person who is an authorized user of the vehicle 12. The biometric sensors 70, 72, 74, 76 may include one or more fingerprint sensors 76, which may be located on an exterior and/or an interior of the vehicle 12, and which may be operably connected to the security controller 20 to authenticate a person who is an authorized user of the vehicle 12.

The system 10 also includes one or more access control devices 82, 84, 86 in the vehicle 12, and which selectively control access to one or more vehicle functions. The access control devices 82, 84, 86 may include one or more door lock actuators 82 for controlling physical access to an interior of the vehicle 12. The access control devices 82, 84, 86 may include one or more closure motors 84, which may be operable to open or close a closure, such as a door, trunk, liftgate, tailgate, etc. of the vehicle 12. The access control devices 82, 84, 86 may include an ignition interlock 86 for selectively controlling an ability of a user to operate the vehicle 12. These are merely examples, and the access control devices 82, 84, 86 may include other devices and/or constraints on functions of the vehicle 12.

In some embodiments, the user device 40 is further configured to present a prompt for an additional confirmation regarding access to the vehicle 12. The security controller 20 may be further configured to prevent access to the vehicle 12 unless and until a response to the prompt for additional confirmation is received. Such additional prompts may be presented at regular intervals, at random intervals, and/or in response to specific trigger events. For example, the system 10 may be configured to determine a geographic location of the vehicle 12 and to present the prompt for the additional confirmation based on the geographic location of the vehicle 12.

In another example, the system 10 may be configured to determine a usage of the vehicle 12 that deviates from a regular usage pattern of the vehicle 12. Detection of such unusual usage may function as a trigger event for prompting for the additional confirmation regarding the access to the vehicle. Determining the regular usage pattern may include learning normal operating patterns of the vehicle over time. Additionally or alternatively, the system 10 may increase a frequency of the prompts for additional confirmation if the vehicle 12 is operated outside of normal or regular usage patterns. This may function similar to credit card fraud detection systems.

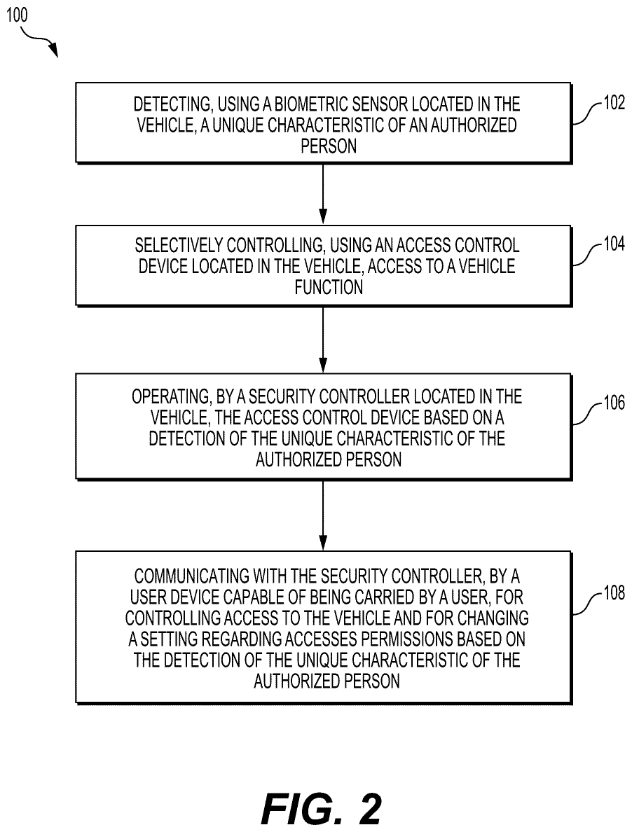

A method 100 for authenticating a user of a vehicle is shown in the flow chart of FIG. 2. As can be appreciated in light of the disclosure, the order of operation within the method is not limited to the sequential execution as illustrated in FIG. 2, but may be performed in one or more varying orders as applicable and in accordance with the present disclosure.

The method 100 includes detecting, at step 102 and using a biometric sensor located in the vehicle, a unique characteristic of an authorized person. Step 102 may be performed by the one or more biometric sensors 70, 72, 74, 76, in combination with the security controller 20.

The method 100 also includes selectively controlling, at step 104 and using an access control device located in the vehicle, access to one or more vehicle functions. For example, step 104 may include operating one or more of the access control devices 82, 84, 86 in the vehicle 12 to selectively control access to one or more vehicle functions.

The method 100 also includes operating, at step 106 and by a security controller located in the vehicle, the access control device based on a detection of the unique characteristic of the authorized person. For example, step 104 may include the security controller 20 commanding one or more of the access control devices 82, 84, 86 in the vehicle 12 to perform a particular function and in response to detecting the unique characteristic of the authorized person (i.e., based on step 102).

The method 100 also includes communicating with the security controller, at step 108 and by a user device capable of being carried by a user, for controlling access to the vehicle and for changing a setting regarding accesses permissions based on the detection of the unique characteristic of the authorized person. For example, the user device 40 may include an app. that provides for vehicle security control and settings, enabling an authorized user to access the vehicle 12 and/or to control system settings, such as authorization of particular individuals for specific vehicle functions.

In some embodiments, the biometric sensor includes at least one of: a camera, a microphone, or a fingerprint sensor.

In some embodiments, the biometric sensor includes a camera, and the security controller may be configured to perform facial recognition based on image data from the camera and to identify the authorized person.

In some embodiments, the biometric sensor includes a microphone, and the security controller is configured to perform voice recognition based on audio data from the microphone and to identify the authorized person.

In some embodiments, the user device includes an application configured to present controls for changing the setting regarding accesses permissions.

In some embodiments, the setting regarding accesses permissions of step 108 includes a setting regarding a particular person as the authorized person.

In some embodiments, the setting regarding accesses permissions of step 108 includes at least one of: a setting regarding vehicle functions available to the particular person, or a setting regarding at least one of a number of uses for the particular person to access a given vehicle function, or a period of time available to the particular person to access the given vehicle function.

In some embodiments, the user device may be further configured to remotely disable a given vehicle function of the vehicle.

In some embodiments, the user device may be further configured to: measure a biometric characteristic of the authorized person; and send, to the security controller, data regarding the biometric characteristic of the authorized person, and wherein the security controller is configured to use the data regarding the biometric characteristic of the authorized person for determining the unique characteristic of the authorized person.

In some embodiments, changing the setting regarding accesses permissions includes the user device being further configured to set a particular person as an authorized person for a set number of access instances, a set period of time, or for an indefinite amount of time.

In some embodiments, the method 100 further includes: presenting a prompt for an additional confirmation regarding access to the vehicle; and preventing, by the security controller, access to the vehicle unless a response to the prompt for additional confirmation is received.

In some embodiments, the method 100 further includes at least one of: determining a geographic location of the vehicle and presenting the prompt for the additional confirmation based on the geographic location of the vehicle; and/or determining a usage of the vehicle that deviates from a regular usage pattern of the vehicle, and presenting the prompt for the additional confirmation based on the usage of the vehicle deviating from the regular usage pattern of the vehicle.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one or more of the above devices as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A multi-factor authentication system for a vehicle, comprising:
a biometric sensor located in the vehicle and configured to detect a unique characteristic of an authorized person;
an access control device located in the vehicle and configured to selectively control access to a vehicle function;
a security controller located in the vehicle and configured to operate the access control device based on a detection of the unique characteristic of the authorized person; and
a user device capable of being carried by a user and configured to communicate with the security controller for controlling access to the vehicle and for changing a setting regarding accesses permissions for controlling operation of the access control device based on the detection of the unique characteristic of the authorized person.

2. The multi-factor authentication system of claim 1, further comprising: a key fob;
and wherein the security controller is further configured to operate the access control device based on a signal from the key fob.

3. The multi-factor authentication system of claim 1, wherein the biometric sensor includes at least one of: a camera, a microphone, or a fingerprint sensor.

4. The multi-factor authentication system of claim 3, wherein the biometric sensor includes a camera, and wherein the security controller is configured to perform facial recognition based on image data from the camera and to identify the authorized person.

5. The multi-factor authentication system of claim 3, wherein the biometric sensor includes a microphone, and wherein the security controller is configured to perform voice recognition based on audio data from the microphone and to identify the authorized person.

6. The multi-factor authentication system of claim 1, wherein the user device includes an application configured to present controls for changing the setting regarding accesses permissions.

7. The multi-factor authentication system of claim 1, wherein the setting regarding accesses permissions includes a setting regarding a particular person as the authorized person.

8. The multi-factor authentication system of claim 7, wherein the setting regarding accesses permissions includes a setting regarding vehicle functions available to the particular person.

9. The multi-factor authentication system of claim 7, wherein the setting regarding accesses permissions includes a setting regarding at least one of a number of uses for the particular person to access a given vehicle function, or a period of time available to the particular person to access the given vehicle function.

10. The multi-factor authentication system of claim 1, wherein the user device is further configured to remotely disable a given vehicle function of the vehicle.

11. The multi-factor authentication system of claim 1, wherein the user device is further configured to:
measure a biometric characteristic of the authorized person; and
send, to the security controller, data regarding the biometric characteristic of the authorized person, and wherein the security controller is configured to use the data regarding the biometric characteristic of the authorized person for determining the unique characteristic of the authorized person.

12. The multi-factor authentication system of claim 1, wherein changing the setting regarding accesses permissions includes the user device being further configured to set a particular person as an authorized person for a set number of access instances, a set period of time, or for an indefinite amount of time.

13. The multi-factor authentication system of claim 1, wherein the user device is further configured to present a prompt for an additional confirmation regarding access to the vehicle, and wherein the security controller is further configured to prevent access to the vehicle unless a response to the prompt for additional confirmation is received.

14. The multi-factor authentication system of claim 13, wherein the system is configured to determine a geographic location of the vehicle and to present the prompt for the additional confirmation based on the geographic location of the vehicle.

15. The multi-factor authentication system of claim 13, wherein the system is configured to determine a usage of the vehicle that deviates from a regular usage pattern of the vehicle, and
wherein the system is further configured to present the prompt for the additional confirmation based on the usage of the vehicle deviating from the regular usage pattern of the vehicle.

16. A method for authenticating a user of a vehicle, comprising:
detecting, using a biometric sensor located in the vehicle, a unique characteristic of an authorized person;
selectively controlling, using an access control device located in the vehicle, access to a vehicle function;
operating, by a security controller located in the vehicle, the access control device based on a detection of the unique characteristic of the authorized person; and
communicating with the security controller, by a user device capable of being carried by a user, for controlling access to the vehicle and for changing a setting regarding accesses permissions based on the detection of the unique characteristic of the authorized person.

17. The method of claim 16, wherein the setting regarding accesses permissions includes a setting regarding a particular person as the authorized person.

18. The method of claim 17, wherein the setting regarding accesses permissions includes at least one of: a setting regarding vehicle functions available to the particular person, or a setting regarding at least one of a number of uses for the particular person to access a given vehicle function, or a period of time available to the particular person to access the given vehicle function.

19. The method of claim 16, further including:
presenting a prompt for an additional confirmation regarding access to the vehicle; and
preventing, by the security controller, access to the vehicle unless a response to the prompt for additional confirmation is received.

20. The method of claim 19, further including at least one of:
determining a geographic location of the vehicle and presenting the prompt for the additional confirmation based on the geographic location of the vehicle; or
determining a usage of the vehicle that deviates from a regular usage pattern of the vehicle, and presenting the prompt for the additional confirmation based on the usage of the vehicle deviating from the regular usage pattern of the vehicle.
